(19) United States
(12) Patent Application Publication
(10) Pub. No.: US 2013/0304243 A1
(43) Pub. Date: Nov. 14, 2013

(54) METHOD FOR SYNCHRONIZING DISPARATE CONTENT FILES

(71) Applicant: VYCLONE, INC, HOLLYWOOD, CA (US)

(72) Inventor: Markus ISELI, Los Angeles, CA (US)

(21) Appl. No.: 13/891,096

(22) Filed: May 9, 2013

Related U.S. Application Data
(60) Provisional application No. 61/644,781, filed on May 9, 2012.

(51) Int. Cl. G06F 17/00

(52) U.S. Cl. CPC G06F 17/00
USPC 700/94

(57) ABSTRACT

The system allows the rapid normalization and synchronization of a plurality of content files using an audio synchronization scheme that reduces computational overhead and provides reliable results. In one embodiment, the system accepts a plurality of content files, performs spectral peak extraction and performs correlation in the log-frequency domain using subtraction. This is used to calculate a reliable confidence score for the calculated correlation. The system uses short duration samples from the beginning and end of a content file and limits the frequencies being matched to time-delay estimation in a very processing-efficient manner.

This patent application claims priority to U.S. Provisional Patent Application 61/644,781 filed on May 9, 2012 which is incorporated by reference herein in its entirety.

### BACKGROUND

There are a number of situations where a number of people are having a shared experience and it would be desirable to have a video record of the experience. In the current art, this would involve one or more of the participants recording the experience, such as with a video camera or a smart-phone or some other mobile device. The person making the recording might then forward the video to others via email or a social media website, twitter, YouTube, or the like. If two or more people made recordings, the different recordings might also be shared in the same manner.

Sometimes there may not be any single content file that encompasses the entire event. In that situation it may be desired to stitch together two or more content files to create a single file that provides a more complete recorded version of the event.

Such a combining of content files involves the ability to assign a given content file its proper location in space and time. In the prior art this is sometimes accomplished by using other content files to help in defining a timeline on which each content file may be placed. Provided with multiple content files, such as video/audio recordings, it is possible to group and assign recordings to events, and find the sequence and overlap of each of the recordings within an event.

In the prior art, the synchronization of content files may be accomplished by using audio information to enable matching of content files with their appropriate location in time. In some cases, a song or tune may be available as part of the audio information. In this case the prior art provides a method for assignment by tune using acoustic fingerprints http://en.wikipedia.org/wiki/Acoustic_fingerprint: such as systems known as Shazam, Midomi, SoundHound, Outlisten, Switchcam, Pluralize, and Wang, A. (2003). An Industrial Strength Audio Search Algorithm. In H. H. Hoos & D. Bainbridge (Eds.), International Conference on Music Information Retrieval ISMIR (pp. 7-13). The Johns Hopkins University.

Another prior art approach is assignment by ambient noise using acoustic location fingerprints such as found in the iPhone app known as “Batphone” (http://www.mccormick.northwestern.edu/news/articles/article_{—}935.html).

Another prior art approach uses correlation type algorithms such as described in Knapp, C. H., & Carter, G. C. (1976). The Generalized Correlation Method For Estimation Of Time Delay. IEEE Transactions on Acoustics, Speech, and Signal Processing, 24(4), 320-327.

### SUMMARY

The system allows the rapid normalization and synchronization of a plurality of content files using an audio synchronization scheme that reduces computational overhead and provides reliable results. In one embodiment, the system accepts a plurality of content files, performs spectral peak extraction and performs correlation in the log-frequency domain using subtraction. This is used to calculate a reliable confidence score for the calculated correlation. The system uses short duration samples from the beginning and end of a content file and limits the frequencies being matched to time-delay estimation in a very processing-efficient manner. The system in one embodiment includes a timed mode that may be used at all times or in certain circumstances, such as, for example, longer content files. Another embodiment implements a precision mode for preventing phase-related attenuation when creating a contiguous audio file from overlapping content sources.

### BRIEF DESCRIPTION OF THE DRAWINGS

FIG. 1 is a flow diagram of an embodiment of the operation of the system.

FIG. 2 is a flow diagram illustrating feature extraction in one embodiment of the system.

FIG. 3 is a flow diagram illustrating the comparison step in one embodiment of the system.

FIG. 4 is a flow diagram illustrating feature comparison in one embodiment of the system.

FIG. 5 is a graph illustrating time delay in an embodiment of the system.

FIG. 6 is a graph illustrating confidence score in an embodiment of the system.

FIG. 7 illustrates an example of five content samples received by the system.

FIG. 8 illustrates the ordering of the content samples.

FIG. 9 illustrates the timeline created after application of the system.

FIG. 10 is a flow diagram illustrating the use of the confidence score to assemble the samples in an embodiment of the system.

FIG. 11 is a flow diagram illustrating the operation of the Timed Mode in an embodiment of the system.

FIG. 12 is a flow diagram illustrating the operation of Precision Mode in an embodiment of the system.

FIG. 13 is an example computer system embodiment of the system.

### DETAILED DESCRIPTION OF THE SYSTEM

The system receives a plurality of content files, each of which may have separate lengths, amplitudes, fidelity, and the like. In one embodiment, the system seeks to define the longest possible continuous combined file that does not have any gaps. This may comprise a plurality of overlapping content files that are assigned to their appropriate point in time on an event timeline.

FIG. 7 illustrates a plurality of content files that may be received by the system. As each of a plurality of content files is received by the system, they are identified, collected, and associated with an event. An event is a collection of content files that relate to the same thing and are related in some way. In the example shown, there are five content files, S1-S5. The event may be a concert, party, sporting event, or some other circumstance where a plurality of users create content (i.e. video) files using recording devices such as smartphones, PDA's, tablets, camcorders, pads, and the like.

The system receives content files and identifies them as belonging to the same event. This may be by user provided tags or data, geolocation and time data, or by some other means. Each content file may be a different length and may have its own start and stop points. For example, file S2 in FIG. 7 is the longest content file, while file S4 is the shortest. The system then attempts to synchronize the disparate files so that content that records the same moment in time is identified appropriately.

Referring briefly to FIG. 9, the actual relationship of the files to each other is shown. It can be seen that file S1 has the earliest start time of the event set of files. Subsequently file S2 begins. At some later time file S1 ends, with a gap in time before file S3 begins recording. That gap in time is not a problem because file S2 overlaps that gap and can provide content. As noted above, one goal of an embodiment of the system is to assemble the longest contiguous content file from a plurality of disparate content files, with no gaps in the assembled content file. Therefore there must be at least one content file available in all time periods from the earliest record point to the latest stop point.

FIG. 1 is a flow diagram illustrating the operation of an embodiment of the system. At step 101 the system receives a plurality of content files. These files are determined to be related to an event and are from approximately the same time. It is possible that the timing of the files overlaps or that some files are independent in time (i.e. do not overlap) from one or more other files.

In one embodiment, it is contemplated that the files are created on personal recording devices such as smart phones. Each user may not begin and end a recording at the same time. However, for some time period, at least one of the users is providing content of the event. As a result, it is possible to assemble the files on a time line so that over some time period from time T₀ to Tₙ, there is at least one content file that is present for each time Tₖ in the time line. The system seeks to use the audio tracks of the content files to synchronize the content files and identify those points in time where one or more files overlap.

At step 102 the system performs signal extraction on each content file. This is the splitting of the audio track from the video file using some technique. In one embodiment, the system may use a tool such as FFmpeg. Any suitable audio extraction technique may be used without departing from the scope and spirit of the system. At step 103 the system normalizes the audio track, converting it from its source format to some other desired format so that the various audio tracks may be manipulated consistently. In one embodiment, the system converts each audio track to a .wav file format.

At step 104 the system downsamples the .wav file to a consistent sampling and bit rate, e.g. 8 kHz and 16 bit samples. At step 105 the system performs feature extraction. In one embodiment this includes generating a spectrogram of the audio signal.

At step 106 the system performs a comparison of each audio file to every other audio file in the event set to determine where in the time line the file is in relation to other files. At step 107 the system assigns a confidence score to the results of the comparison, representing the likelihood that a match of two files as having at least some common audio is correct.

At step 108 the system determines if all files have been compared. If not, the system returns to step 106. If so, the system ends at step 109.

Feature Extraction

The step of feature extraction 105 is used to maximize spectral discrimination between different signals. This is accomplished through a combination of filtering, enhancing, and clipping as necessary to allow spectral discrimination to be accomplished. The resulting signal is easier to compare with other enhanced signals because identifying features have been emphasized and those portions of the signal that are less discriminate are removed. This allows subsequent steps of signal comparison to be more effective. The feature extraction identifies and enhances signal peaks, removes noise and lower amplitude components, and cleans up the signal to allow more accurate comparison of possible coincident audio signals.

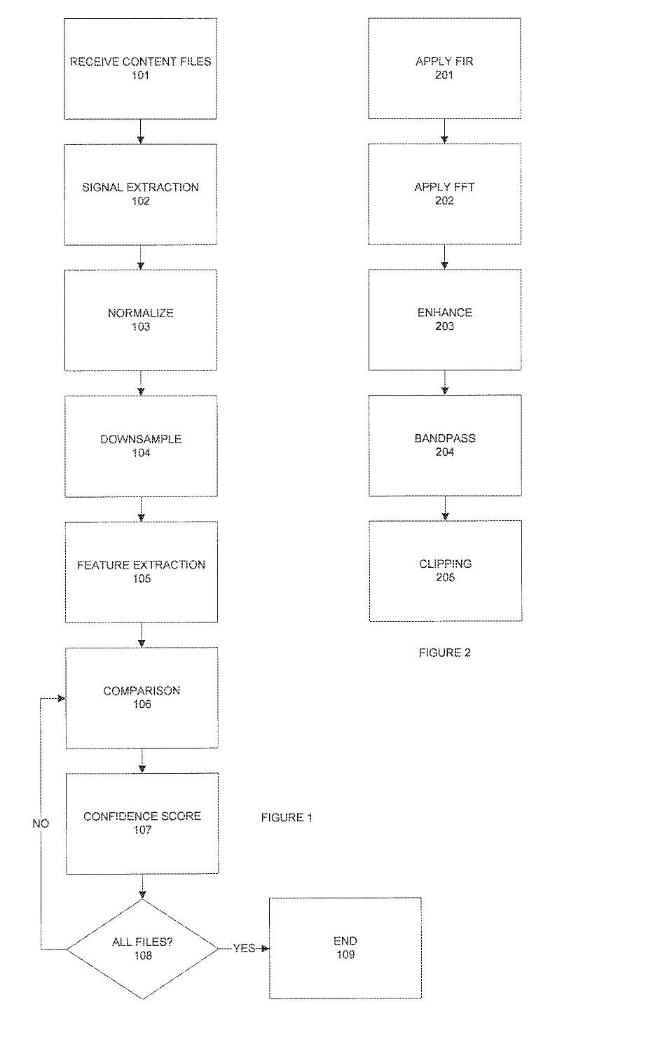

FIG. 2 is a flow diagram illustrating feature extraction in one embodiment of the system. This is applied on a frame by frame basis of the audio signal in one embodiment of the system. At step 201 the system applies a filter (e.g. a finite impulse response FIR filter) to the audio signal. This is a first order finite impulse response (FIR) filter which enhances high frequencies. A goal is to maximize (or at least not reduce) the spectral discrimination between different signals.

At step 202 the system calculates a spectrogram using a 64-point real short-term Fast Fourier Transform (FFT) with 10 ms (milliseconds) frame duration and 10 ms frame shifts, resulting in no frame overlap and a frequency resolution of 125 Hz (Hertz). This step includes Hamming filtering of the frames.

At step 203 the system enhances the signal. This is accomplished in one embodiment by taking the absolute value of each complex frequency component and then subtracting three quarters of the mean of each frame. This step enhances the spectral peaks by removing lower-energy spectral components: For frames with background noise, the mean of the noise is removed. For frames with noise plus signal the noise is removed. For frames with signal only, weaker signal (non-landmark) components are removed. The result is a signal with identifiable and somewhat isolated peaks that enhance the ability of the system to apply comparison techniques to the signals and identify coincident time periods.

At step 204 applies a band-pass filter to the enhanced signals. In one embodiment, the system disregards (i.e. Band-pass filters out) the first five and last five frequency bins out of the FFT array. This results in removal of frequency components below 600 Hz and above 3400 Hz. This is an advantage because some cell phone microphones have a frequency response such that audio is likely to be distorted at low frequencies. Other models may have distortion at higher frequencies. Removing this potentially distorted signal does allows for improved matching capability.

At step 205 a clipping operation is performed by clipping the spectral amplitude at 1.0 and taking the logarithm. This step reduces the dynamic range of the signal and mimics the human auditory system. The result, for each frame, is a spectrogram that is stored in an array.

Comparison

After feature extraction, the signals are now suitable for comparison and matching. FIG. 3 is a flow diagram illustrating the comparison step in one embodiment of the system. At step 301, the features of the audio files are sorted by duration.

Example: Assume the audio files, F1, F2, and F3, with their corresponding features X1, X2, X3 are sorted by duration, d( ), as d(F1)<=d(F2)<=d(F3) with F1 having the shortest duration. The features are sorted as [X1, X2, X3].

This sorting can be shown graphically in FIG. 8 where the shortest file, S4, is followed by (in order of increasing duration) file S1, S5, S3, and S5.

At step 302, starting with the shortest remaining file, the features of the shortest audio file are then compared to the features of all audio files with longer duration at step 303. Example: Given d(F1)<=d(F2)<=d(F3), we compare(X1,X2) and compare(X1,X3).

Referring again to FIG. 8, this means that file S4 would be compared to files S1, S5, S3, and S2. File S1 would only be compared to longer duration files S5, S3, and S2. File S5 is compared to file S3 and S2, and file S3 is compared to file S2.

At step 304, the system generates a time delay estimate for each comparison of the sample point with the longer remaining files. Each comparison between two files returns a time-delay estimate, resolution 10 ms, together with a confidence score that ranges between zero and one, one representing highest confidence in the time-delay estimate and zero meaning no confidence. Example: compare(X1,X2)=[120 ms, 0.6], which would indicate that X2 starts 120 ms after X1 starts, with a confidence score of 0.6 and compare(X1,X3)=[−120 ms, 0.2], which would indicate that X3 starts 120 ms before X1 starts, with a confidence score of 0.2.

At decision block 305, the system determines if there are any more files to compare. If not, the system ends at step 306. If so, the system returns to step 302 and the features of the next shortest duration audio file are compared to the features of all audio files with longer duration. Example: Given d(F1)<=d(F2)<=d(F3), compare(X2,X3). This process is repeated until all audio file features have been compared. Given N files, this will require N choose 2 or N!/(N−2)!/2 comparisons.

Feature Comparison

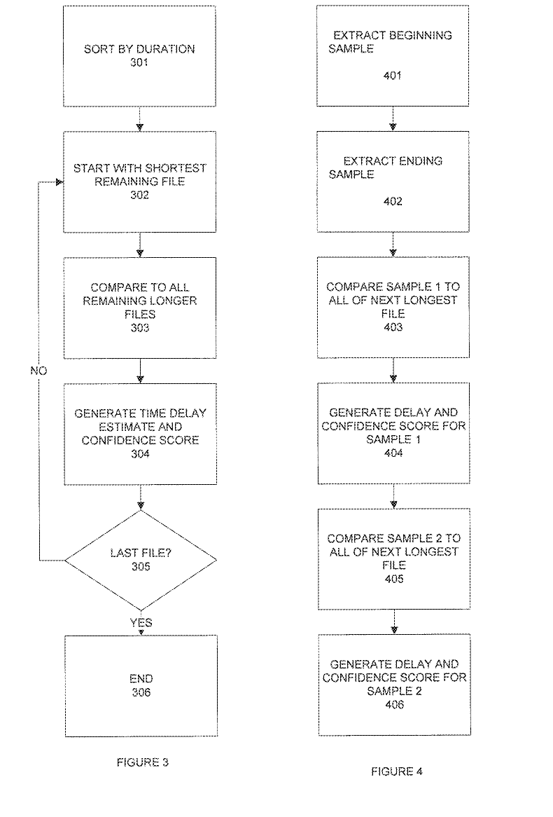

The feature comparison step 303 is described in connection with the flow diagram of FIG. 4. In order to increase the efficiency of the feature comparison process which calculates time-delay and confidence score, the algorithm compares only the first few seconds from the start and the end of the shorter duration signal to the longer duration signal. In one embodiment the system uses 2 second samples. Using short-duration beginning and end segments for comparison has two benefits: a) it reduces the computational load from order of duration squared, O(d²), to approximately linear, O(d), and b) it allows for negative and non-complete overlaps of audio signals. Example: Assume that X1b represents the features of the first q seconds of X1, the beginning of X1, and X1e represents the spectral features of the last q seconds of X1, the end of X1. Then we compare (X1b,X2) and compare (X1e,X2). Given two audio files F1 and F2, where F1 starts at least q seconds before F2 ends and ends at least q seconds after F2 ends, with d(F1)<=d(F2). compare(X1,X2) and compare(X1e,X2) will yield respectively, a time-delay with low-confidence since there is no complete overlap, whereas compare(X1b,X2) will yield a time-delay with high confidence since there is complete overlap.

At step 401 the system extracts Sample 1, the beginning q seconds of the shortest file and at step 402 extracts Sample 2, the ending q seconds of the shortest file. At step 403 the system compares Sample 1 to all of the next longest files and generates a time delay and confidence score at step 404. At step 405 the system compares Sample 2 to all of the next longest files and generates a time delay and confidence score at step 406. In one embodiment, if there is a high level confidence score for Sample 1, above some predetermined threshold, the system can optimize the comparison step by beginning the Sample 2 comparison at the high confidence point, since we can assume that any synchronization point of Sample 2 must occur sometime after the synchronization point of Sample 1.

Note that in some approaches, correlation between two time-signals x(t) and y(t) is done in the frequency domain by addition of the corresponding log-spectra logX(f) and logY(f). By contrast, this system calculates the absolute difference between the log-spectra features (described above under feature extraction) of each frame resulting in an optimum of zero difference if the frames have equal spectrograms. Compared to other methods, this method has the clear benefit of introducing an optimum lower bound at zero so that all results can be interpreted relative to this optimum and a confidence score can be calculated.

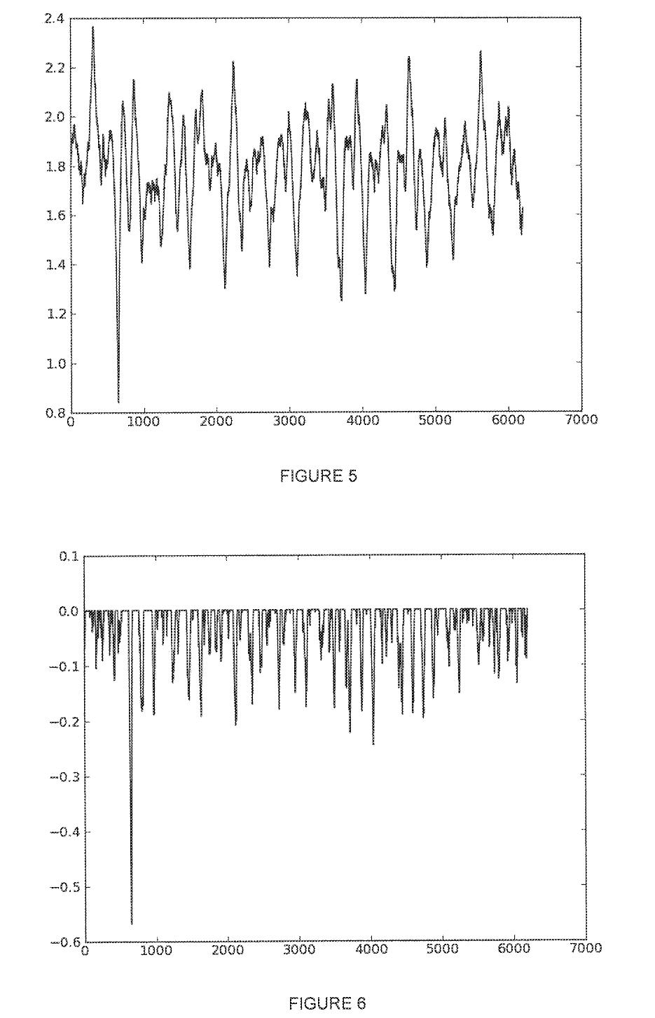

Each frame comparison yields a two-dimensional spectrogram-like feature difference that is then reduced to a scalar value by taking its mean over time and over frequency dimensions. Since time-delay between two signals determines which of their feature frames will be compared, a scalar feature difference can be calculated for each time-delay value resulting in a graph that shows the time-delay on the abscissa and the scalar feature difference on the ordinate. The minimum value will indicate the time-delay. FIG. 5 illustrates an example of such a graph. It can be seen that the minimum scalar feature difference is about 0.84 at time 6.55 s (655*10 ms), which corresponds to an estimate of the optimal time-delay.

Confidence Score

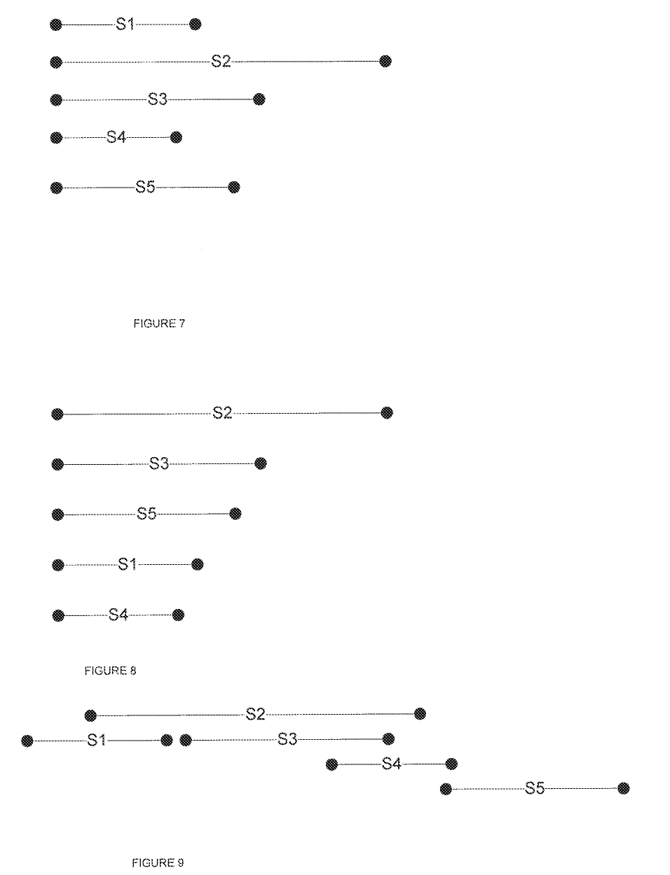

In order to compute a reliable confidence score the above scalar feature difference graph of FIG. 5 is high-pass filtered to accentuate the negative peaks. Additionally the mean is removed. FIG. 6 is an example graph that shows the results of these operations on the signal of FIG. 5. The minimum peak is now at −0.569 (MIN1) with its time location unchanged at 6.55 s. Once the location of the minimum peak has been determined, all consecutive non-zero values to the left and to the right of the peak are set to zero and the next minimum peak is detected. This next peak is located around time 40.45 s (4045*10 ms) and is at −0.246 (MIN2) in the example shown. The confidence score is calculated as the difference between the first and the second minimum peak values, normalized by the first minimum peak value, as (MIN1−MIN2)/MIN1. In this example: (−0.569−−0.246)/0.569=0.568.

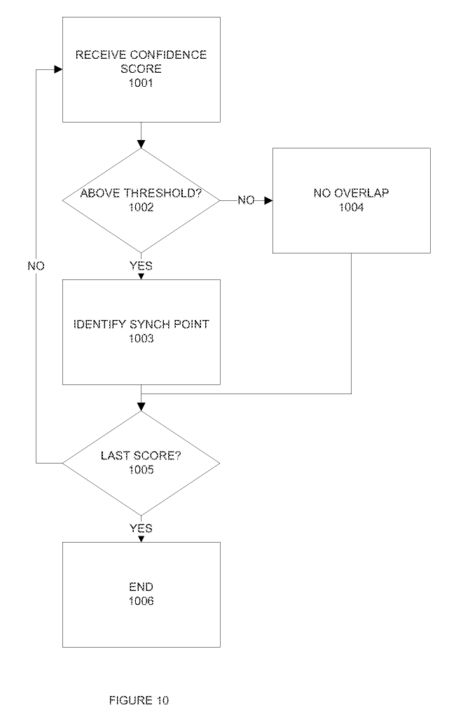

FIG. 10 is a flow diagram illustrating the use of the confidence scores to establish the synchronization and relationship between the received event content files. At step 1001 the system receives the confidence scores as they are generated by the operation of FIG. 1. At decision block 1002 the system compares the confidence score to a predetermined threshold. If it is above the threshold, the system assumes that there is a high likelihood of a match and establishes a synchronization point at that location in the two samples at step 1003. In one embodiment the confidence score should be above 0.4 to indicate synchronization.

At step 1003, the system identifies the synchronization point between the two files and builds a table associated with the event files. For example, in the example herein, the file S4 will not have a high enough confidence score for its first two sample points because there is no overlap between the two shortest files S4 and S1. The fourth sample point of Sample S4 (i.e. its ending sample point compared to file S5) will have a confidence score above the threshold, indicating an overlap.

If the confidence score is below the threshold at decision block 1002, the system proceeds to step 1004, indicates no overlap, and proceeds to decision block 1005.

At decision block 1005 it is determined if the last confidence score has been reviewed, if so, the system ends at step 1006. If not, the system returns to step 1001 and receives the next confidence score.

After all the confidence scores have been analyzed, the system has identified the synchronization points of all of the files and the relationship shown in FIG. 9 has been established.

As shown in FIG. 9, the content files have been sorted using the system and the files are arranged based on the confidence score generated in previous steps. This allows the relationship of the files in time to be revealed. For example, file S1 is the earliest content file in time and the end of file S1 overlaps partially with file S2. File S3 completely overlaps with file S2 and partially with file S4. File S4 has partial overlap (at its beginning) with file S2 and S3, and has partial overlap (at is end) with file S5. The system now has the ability to create, using all or some of each content file, a continuous (in time) file of an event from the earliest moment (beginning of file S1) to the latest moment (end of file S5). As can be seen, there are certain regions on the time line where the content from any of files S2, S3, and S4 could be used as the source of the content for that period of time. This choice may be automated and/or manually determined by the user.

Timed Mode

In one embodiment, the system implements a timed mode that reduces the computation load when comparing long content files. In one embodiment, timed mode is implemented for files over a certain threshold of length (e.g. 10 minutes in length). In other instances, timed mode is used for all files, regardless of length. In timed mode, it is assumed that the time of occurrence of the content file events is known to a certain precision, e.g. +−40 seconds, and the comparison algorithm only operates within this limited time window. Since the metadata information of content files, e.g. video files recorded on a cell phone, is typically present, this mode provides an effective reduction of computational load and thus comparison time. Content file time stamps and overall time stamp precision should be specified in this mode.

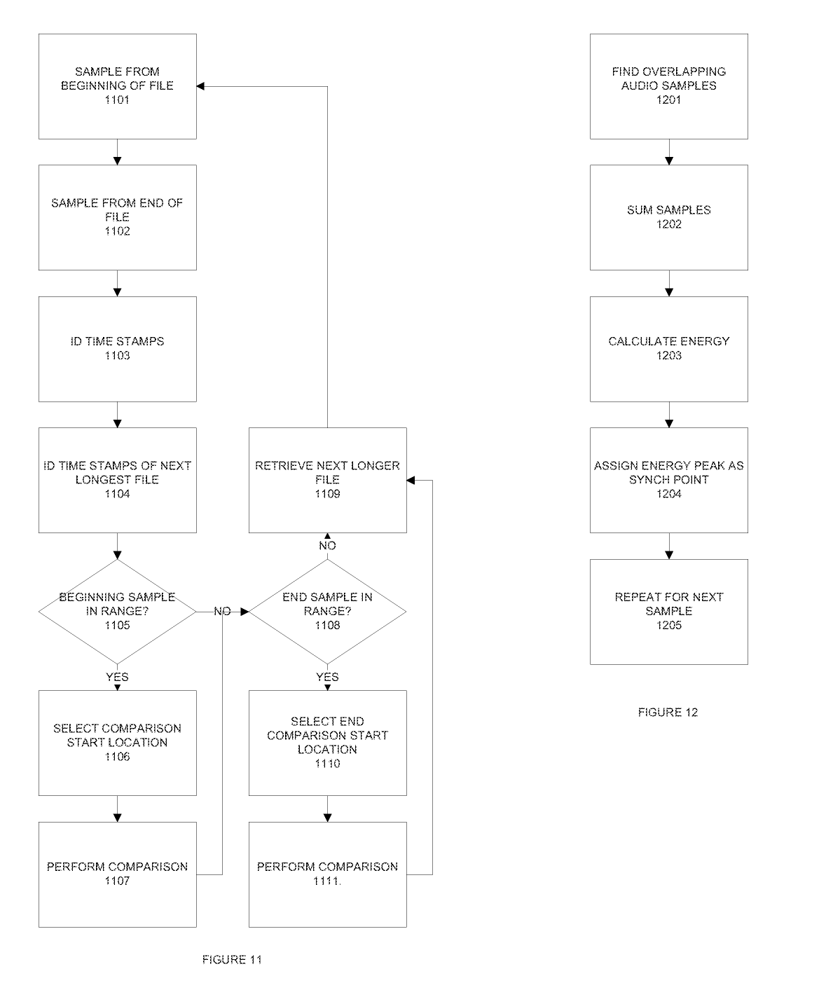

The timed mode uses the timestamp metadata from the recording device and associated with a content file to get a head start on where to look in a second file to begin synchronizing with a first file. FIG. 11 is a flow diagram illustrating the operation of the timed mode in an embodiment of the system. In one embodiment, the steps of FIG. 10 are used instead of the steps of FIG. 4.

The system has files with associated timestamp metadata indicating start time and stop time. When comparing two files using timed mode, the system begins with the shorter file and takes some time period (e.g. 2 seconds) from the beginning (step 1101) and end (step 1102) of the file. Those extracted time samples will be compared to the next longer available file to find a point of synchronization.

However, in Timed Mode, instead of comparing the extracted time samples of the shorter file to the entire longer file, the system instead utilizes the metadata to choose a region of the longer file. The system assumes that the timestamps (and by extension the clock) on smart phones are already relatively synchronized to a certain precision, which can be specified explicitly in this mode (the default is +/−40 seconds). Given these timestamps, the system calculates the time offset between the shorter and the longer file.

At step 1104 the system identifies the start time and end time of the next longest file. For purposes of this example, assume the start time is 8:06 and the end time is 9:12 (e.g. over an hour of content). Referring again to FIG. 9, if the two samples to be compared are samples S1 and S2, it can be seen that the beginning of sample S1 is not likely to be found in sample S2, but the end of sample S1 is likely to be found in sample S2. By contrast, if we look at samples S3 and S2, both the beginning and end of sample S3 would be likely to be found within sample S2 based on the start and timestamps of the respective files.

Next, at decision block 1105, the system determines if the beginning sample is within the time range of the next longest file. In this case, the beginning sample time of 8:04 is not within the range of one or both of these times are likely to be overlapping with the second sample (within some defined range). For example, if the first sample begins recording some time before the start time of the second sample, it would be unlikely for the beginning extracted time period to be found in the second sample. However, if the ending extracted time period is both after the beginning of the second sample, and before the end of the second sample, then, the ending extracted time period will be analyzed and the beginning extracted time period will be ignored. However, if the beginning sample point were in range, the system proceeds to step 1106 and selects the portion of the next longest file that corresponds to the start time of the beginning sample plus some additional window (e.g. +/−40 seconds). At step 1107 the system performs the comparison of the sample point with the selected portion and generates the delay and confidence score for the comparison.

If the beginning sample is not within the time range at decision block 1105, or after step 1107, the system proceeds to decision block 1108 to determine if the ending sample is within the time range of the next longest file. If not, the system retrieves the next longer sample at step 1109 and returns to step 1101.

If the ending sample is within the range at decision block 1108, the system proceeds to step 1110 and selects the portion of the next longest file that corresponds to the start time of the ending sample plus the additional window. At step 1111 the system performs the comparison of the sample point with the selected portion and generates the delay and confidence score for the comparison. After step 1111 the system returns to step 1109.

Precision Mode

One embodiment of the system allows a user to create a contiguous composite file comprised of portions of disparate overlapping files with a synchronized audio track. (An example of generating a composite file is described in pending U.S. patent application Ser. No. 13/445,865 filed Apr. 12, 2012 and entitled “Method And Apparatus For Creating A Composite Video From Multiple Sources” which is incorporated by reference herein in its entirety). Each content file has its own associated audio track and there might not be any single file that overlaps the entire composite video. Therefore, the audio track must be built from portions of the audio tracks of different content files.

The amplitude and phase of the various audio tracks may not match up appropriately. For example, the physical locations of the cameras to the audio source (e.g. a speaker, performer, and the like) may impact the amplitude of the audio track. Some may be much louder than others while some may be garbled or faint. In addition, the sampling rate of the various audio tracks may be different.

It is desired to create a composite audio track that blends appropriately and sounds consistent over the extent of the composite file. However, a problem arises when there is a phase difference between the source tracks due to varying distances to the sound source from the recording devices. A phase difference could end up cancelling out audio signals, causing loss of data. Before combining audio signals, the system uses Precision Mode to normalize the distance from the source of each audio file to minimize phase shift. This allows the audio file to be combined into a composite file.

Precision Mode finds the offsets of the content files to coordinate for phase shift by shifting the sample points to find where the energy peak is located. After overlapping the audio files using the synchronization points obtained from Feature Comparison, which has a frame-based resolution of 10 ms, the system then searches within a range of +/−5 ms around the synchronization point on an audio sample-by-sample basis to find the energy peak (indicating possible phase match). Since the shifting is done for each sample, the resolution for a sampling frequency of 8 kHz is 1/8000 seconds, which corresponds to 125 us (micro seconds). Precision mode is used to prevent phase-related attenuation when creating one contiguous audio file from the sum of all overlapping content files.

FIG. 12 is a flow diagram illustrating the operation of the Precision Mode in one embodiment of the system. At step 1201 the system finds the audio samples that are overlapping. At step 1202 the system takes a sample of a first audio track sums it with a second audio track over a time range (e.g. +/−5 milliseconds) from the initial estimated synchronization point.

At step 1203 the system calculates the energy of the combined signals. At step 1204 the system assigns the energy peak as the phase related location of the signals and uses that location as the synchronized location. At step 1205 the system continues for all sample points.

Embodiment of Computer Execution Environment (Hardware)

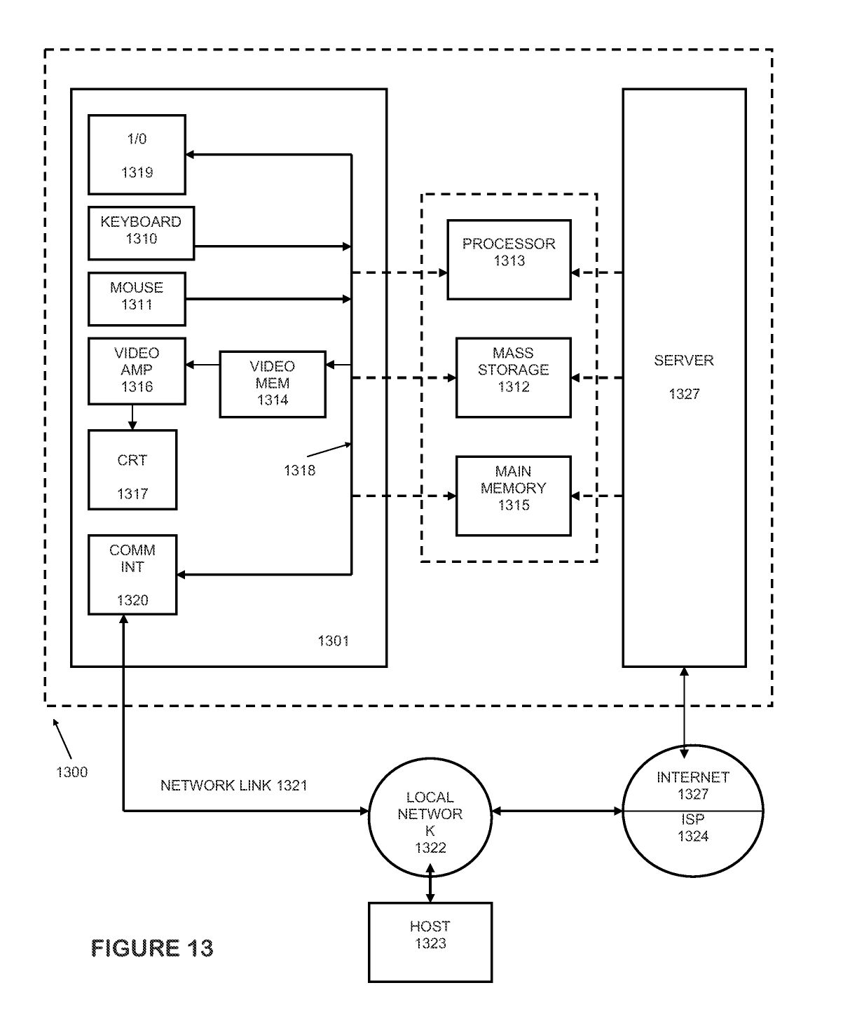

An embodiment of the system can be implemented as computer software in the form of computer readable program code executed in a general purpose computing environment such as environment 1300 illustrated in FIG. 13, or in the form of bytecode class files executable within a Java™ run time environment running in such an environment, or in the form of bytecodes running on a processor (or devices enabled to process bytecodes) existing in a distributed environment (e.g., one or more processors on a network). A keyboard 1310 and mouse 1311 are coupled to a system bus 1318. The keyboard and mouse are for introducing user input to the computer system and communicating that user input to central processing unit (CPU 1313. Other suitable input devices may be used in addition to, or in place of, the mouse 1311 and keyboard 1310. I/O (input/output) unit 1319 coupled to bi-directional system bus 1318 represents such I/O elements as a printer, A/V (audio/video) I/O, etc.

Computer 1301 may be a laptop, desktop, tablet, smart-phone, or other processing device and may include a communication interface 1320 coupled to bus 1318. Communication interface 1320 provides a two-way data communication coupling via a network link 1321 to a local network 1322. For example, if communication interface 1320 is an integrated services digital network (ISDN) card or a modem, communication interface 1320 provides a data communication connection to the corresponding type of telephone line, which comprises part of network link 1321. If communication interface 1320 is a local area network (LAN) card, communication interface 1320 provides a data communication connection via network link 1321 to a compatible LAN. Wireless links are also possible. In any such implementation, communication interface 1320 sends and receives electrical, electromagnetic or optical signals which carry digital data streams representing various types of information.

Network link 1321 typically provides data communication through one or more networks to other data devices. For example, network link 1321 may provide a connection through local network 1322 to local server computer 1323 or to data equipment operated by ISP 1324. ISP 1324 in turn provides data communication services through the world wide packet data communication network now commonly referred to as the “Internet” 1327 Local network 1322 and Internet 1327 both use electrical, electromagnetic or optical signals which carry digital data streams. The signals through the various networks and the signals on network link 1321 and through communication interface 1320, which carry the digital data to and from computer 1300, are exemplary forms of carrier waves transporting the information.

Processor 1313 may reside wholly on client computer 1301 or wholly on server 1327 or processor 1313 may have its computational power distributed between computer 1301 and server 1327. Server 1327 symbolically is represented in FIG. 13 as one unit, but server 1327 can also be distributed between multiple “tiers”. In one embodiment, server 1327 comprises a middle and back tier where application logic executes in the middle tier and persistent data is obtained in the back tier. In the case where processor 1313 resides wholly on server 1327, the results of the computations performed by processor 1313 are transmitted to computer 1301 via Internet 1327, Internet Service Provider (ISP) 1324, local network 1322 and communication interface 1320. In this way, computer 1301 is able to display the results of the computation to a user in the form of output.

Computer 1301 includes a video memory 1314, main memory 1315 and mass storage 1312, all coupled to bi-directional system bus 1318 along with keyboard 1310, mouse 1311 and processor 1313.

As with processor 1313, in various computing environments, main memory 1315 and mass storage 1312, can reside wholly on server 1327 or computer 1301, or they may be distributed between the two. Examples of systems where processor 1313, main memory 1315, and mass storage 1312 are distributed between computer 1301 and server 1327 include thin-client computing architectures and other personal digital assistants, Internet ready cellular phones and other Internet computing devices, and in platform independent computing environments,

The mass storage 1312 may include both fixed and removable media, such as magnetic, optical or magnetic optical storage systems or any other available mass storage technology. The mass storage may be implemented as a RAID array or any other suitable storage means. Bus 1318 may contain, for example, thirty-two address lines for addressing video memory 1314 or main memory 1315. The system bus 1318 also includes, for example, a 32-bit data bus for transferring data between and among the components, such as processor 1313, main memory 1315, video memory 1314 and mass storage 1312. Alternatively, multiplex data/address lines may be used instead of separate data and address lines.

In one embodiment of the invention, the processor 1313 is a microprocessor such as manufactured by Intel, AMD, Sun, etc. However, any other suitable microprocessor or microcomputer may be utilized, including a cloud computing solution. Main memory 1315 is comprised of dynamic random access memory (DRAM). Video memory 1314 is a dual-ported video random access memory. One port of the video memory 1314 is coupled to video amplifier 1319. The video amplifier 1319 is used to drive the cathode ray tube (CRT) raster monitor 1317. Video amplifier 1319 is well known in the art and may be implemented by any suitable apparatus. This circuitry converts pixel data stored in video memory 1314 to a raster signal suitable for use by monitor 1317. Monitor 1317 is a type of monitor suitable for displaying graphic images.

Computer 1301 can send messages and receive data, including program code, through the network(s), network link 1321, and communication interface 1320. In the Internet example, remote server computer 1327 might transmit a requested code for an application program through Internet 1327, ISP 1324, local network 1322 and communication interface 1320. The received code maybe executed by processor 1313 as it is received, and/or stored in mass storage 1312, or other non-volatile storage for later execution. The storage may be local or cloud storage. In this manner, computer 1300 may obtain application code in the form of a carrier wave. Alternatively, remote server computer 1327 may execute applications using processor 1313, and utilize mass storage 1312, and/or video memory 1315. The results of the execution at server 1327 are then transmitted through Internet 1327, ISP 1324, local network 1322 and communication interface 1320. In this example, computer 1301 performs only input and output functions.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. In other embodiments, the system may be implemented on any suitable computing environment including personal computing devices, smart-phones, pad computers, and the like. An embodiment of the invention may be implemented in any type of computer system or programming or processing environment.

What is claimed is:

1. A method of synchronizing content files comprising:
In a processing system:
Receiving a plurality of content files having audio and video signals;
Extracting the audio signal from each content file;
Sorting the audio signals into a first order;
Comparing a first ordered audio signal to a next ordered audio signal;
Generating a confidence score representing the level of synchronization of the first ordered audio signal to the next ordered audio signal;
Defining the first ordered audio signal as synchronized to the second ordered audio signal when the confidence score exceeds a certain threshold.

2. The method of claim 1 wherein first order comprises shortest to longest content file.

3. The method of claim 1 wherein the step of comparing comprises extracting a first sample from the beginning of the first ordered audio signal and comparing it to the second ordered audio signal.

4. The method of claim 3 wherein the step of comparing comprises extracting a second sample from the end of the first ordered audio signal and comparing it to the second ordered audio signal.

5. The method of claim 4 wherein the extracted beginning sample and the extracted end sample are compared to the entire second ordered audio signal.

6. The method of claim 4 wherein the extracted beginning sample and the extracted end sample are compared to selected portions of the second ordered audio signal.

7. The method of claim 6 wherein the selected portions of the second ordered audio signal are determined by timestamp data associated with the first ordered audio signal and the second ordered audio signal.

8. The method of claim 7 wherein the selected portions are plus or minus 40 seconds from a timestamp value associated with the first ordered audio signal.

9. The method of 8 wherein no comparison is performed when the timestamp value associated the first ordered audio signal is not within the range of beginning and ending timestamps of the second ordered audio signal.

10. The method of claim 1 further including the steps of extracting features from the audio signal by applying a Finite Impulse Response (FIR) filter, applying a Fast Fourier Transform (FFT) to the result; band-pass filtering and clipping the audio signal.
